(19) United States
(12) Patent Application Publication
(10) Pub. No.: US 2013/0132294 A1
(43) Pub. Date: May 23, 2013

(54) System and Method for Engaging a Social Network

(71) Applicant: Aggregift, LLC, New York, NY (US)

(72) Inventors: Gregory E. Schvey, New York, NY (US); Austin K. Lin, New York, NY (US); Jeffrey E. Schvey, New York, NY (US); Norton Wang, Edison, NJ (US)

(73) Assignee: Aggregift, LLC, New York, NY (US)

(21) Appl. No.: 13/683,598

(22) Filed: Nov. 21, 2012

Related U.S. Application Data
(60) Provisional application No. 61/563,297, filed on Nov. 23, 2011.

(51) Int. Cl. G06Q 50/00

(52) U.S. Cl. CPC G06Q 50/01
USPC 705/319

(57) ABSTRACT

A method of engaging a consumer's social network includes promoting a potential gift to members of the consumer's social network, soliciting and receiving contributions to the gift from members of the consumer's social network, and determining whether a trigger condition has been met. The method then provides a gift to the consumer, and the gift may include one or more conditional contributions from the vendor of the gift item, depending on the whether the trigger condition has been met.

### RELATED APPLICATIONS

The present application claims priority to U.S. provisional application Ser. No. 61/563,297, naming Gregory Schvey as inventor, and filed Nov. 23, 2011 and titled “Group Gifting Over A Network,” the disclosure of which is incorporated herein by reference, in its entirety.

### TECHNICAL FIELD

The present inventions relate to social networking, and more particularly to group gifting via social networking.

### BACKGROUND ART

It is common within a social arena that a group of people celebrate one another's special occasions such as birthday, engagement, wedding, graduation, baby shower, etc. Frequently, people want to send gifts but cannot afford to spend a lot of money. Contributions from individuals to a collectively-given gift is common in a social arena among colleagues within a company, or among friends.

To that end, a person often circulates a card and an envelope to collect money for the gift, or a person will buy a gift first and collect money from others afterward. No matter which method is used, the person in charge of collecting money needs to spend time monitoring, organizing and enforcing the process. Additionally, such a process limits potential contributors to the gift to mutual friends/acquaintances of the person who initiated the gift and the gift recipient.

### SUMMARY OF VARIOUS EMBODIMENTS

In accordance with a first embodiment, a method of engaging a recipient and members of a recipient's social network by promoting a potential gift for the recipient and a conditional vendor contribution towards the gift includes posting, from a first server, a message on a user's page in a social networking environment, the message identifying the potential gift, and soliciting contributions to the gift; receiving, at a second server, at least one contribution from at least one contributor; aggregating the one or more contributions to produce aggregated contribution data; determining, based on the aggregated contribution data, whether a trigger condition has been satisfied; and determining a gift to be provided to the recipient, the gift depending on whether the condition has been satisfied. The performance of the various steps may be distributed across two (or more) servers, or may be performed on a single server (e.g., the first and second servers may be the same server). Some embodiments also provide the gift to the recipient (e.g., via electronic delivery), while other embodiments cause the gift to be provided to the recipient.

Some embodiments include, in the gift, a vendor contribution, such as a contribution towards the price of the gift, or a discount from the price of the gift. As such, the method may include determining whether the gift includes a vendor contribution. For example, one or more vendor contributions may be included in the gift if a trigger condition has been satisfied. Accordingly, the method may include determining whether one or more trigger conditions has been satisfied.

In some embodiments, determining whether a trigger condition has been satisfied involves determining whether a first trigger condition has been satisfied, and if so, determining whether a second trigger condition has been satisfied, the first trigger condition associated with a first conditional vendor contribution and the second trigger condition associated with a second conditional vendor contribution; and the method further involves causing a gift to be provided to the recipient wherein the gift includes the first conditional vendor contribution if the first trigger condition has been satisfied, and wherein the gift includes the second conditional vendor contribution if the second trigger condition has been satisfied.

In various embodiments, the method includes receiving information about the gift to be promoted. For example, prior to posting (from a first server) a message on a user's page in a social networking environment, the method may include a step of receiving, at the first server, item promotion data, the item promotion data including at least a specification of the potential gift and the price of the potential gift.

An alternate embodiment includes a non-transient computer readable medium having computer readable code thereon, the computer readable code for engaging a recipient and members of a recipient's social network by promoting a potential gift for the recipient and a conditional vendor contribution towards the potential gift. Such computer code includes code for promoting the potential gift to members of the recipient's social network; code for soliciting contributions from members of the recipient's social network towards the potential gift; code for receiving one or more contributions from one or more contributors; code for determining whether a trigger condition has been satisfied by a pre-determined deadline; and code for causing a gift to be provided to the recipient, the gift including the conditional vendor contribution if the trigger condition has been satisfied.

For example, code for promoting the potential gift to members of the recipient's social network may include code for promoting the potential gift via at least one social networking environment, such as by specifying the potential gift and specifying a conditional vendor contribution. Some embodiments, also include code for receiving item promotion data, the item promotion data including at least a specification of the potential gift and the price of the potential gift.

The code in various embodiments may also include code for causing a credit instrument to be provided to the recipient if the trigger condition has not been satisfied, the credit instrument in an amount less than or equal to the sum of the contributions received.

A system for engaging a recipient and members of a recipient's social network by promoting a potential gift for the recipient and a conditional vendor contribution towards the potential gift includes a promotion module configured to promote the potential gift to members of the recipient's social network via at least one social networking environment; a solicitation module configured to solicit contributions from members of the recipient's social network towards potential gift; a contribution receiving module configured to receive one or more contributions from one or more contributors; a trigger module configured to determine whether a trigger condition has been satisfied by a pre-determined deadline; and a fulfillment module configured to cause a gift to be provided to the recipient, the gift including the conditional vendor contribution if the trigger condition has been satisfied. In various embodiments, the system may also include an information receiving module configured to receive item promotion data, the item promotion data including at least a specification of the potential gift and the price of the potential gift.

In various embodiments, a trigger condition may be receipt of a plurality of contributions from at least a pre-defined number of contributors; or receipt of pre-defined sum of contributions, the pre-defined sum exceeding a pre-defined price of the potential gift; or receipt of a pre-defined sum of contributions, contributed by a pre-defined number of contributors, to name but a few examples.

### BRIEF DESCRIPTION OF THE DRAWINGS

The foregoing features of embodiments will be more readily understood by reference to the following detailed description, taken with reference to the accompanying drawings, in which:

FIG. 1 is a flow chart illustrating an embodiment of a method of engaging a social network;

FIG. 2A is a flow chart illustrating an embodiment of a method of initiating engagement of a social network;

FIG. 2B shows an embodiment of a process of initiating a group gift account for a friend in a social network environment in accordance with illustrative embodiments of the invention;

FIG. 3 shows an embodiment of process for the recipient to accept or reject a group gift in accordance with illustrative embodiments of the invention;

FIG. 4 shows an embodiment of process for the contributor to make contribution to a group gift in accordance with illustrative embodiments of the invention;

FIG. 5 shows an embodiment of a process for assessing compliance with conditions;

FIG. 6 schematically illustrates a system for engaging a social network; and

FIG. 7 schematically illustrates a computer network for engaging a social network.

### DETAILED DESCRIPTION OF VARIOUS EMBODIMENTS

In various embodiments, a person may initiate a process by which a recipient ultimately receives a gift funded by an aggregation of contributions from his friends (e.g., members of the recipient's social network) with a contribution from the vendor of the gift. This results in a win-win-win scenario: the recipient wins by receiving a gift that is more valuable than it would have been if based on the contributions of his friends alone; the friends win by leveraging their contributions with a contribution from the vendor; and the vendor wins by making a sale, and/or by engaging in a positive way with the recipient and the recipient's social network.

Definitions. As used in this description and the accompanying claims, the following terms shall have the meanings indicated, unless the context otherwise requires:

A person receiving or potentially receiving a gift may be referred to as the “giftee” or “recipient” or “consumer,” and a contributor may be that person's “friend” or a “member of the person's social network.”

A social networking platform (or “social networking environment”) is an application or service by which users can communicate or network with one another, such as online networking media Facebook, Linked-In, and Google+, to name but a few.

Some social networking environments allow users to establish and maintain a persistent identifiable presence (e.g., a “profile,” such as a Facebook profile) with the social networking environment, which presence is uniquely identified with that user, such that other people (e.g., other users of that social networking environment, for example) may locate and establish contact with each other through the networking environment. For example, a persistent identifiable presence may include information about the user by which may be searched and found by third parties, and by which third parties may recognize or identify the user as a specific individual. Information supplied to a persistent identifiable presence commonly includes names, photographs, or other biographical information, for example. A user's identifiable presence is persistent in that it exists and is available for access by others at times even when the user is not engaged (e.g., logged-onto) with the social networking environment.

A person's social network typically includes people and entities to whom the person has the ability to send a direct or multi-cast message. For example, a person's social network may include people or entities who engage (or who are “members of”) a social networking environment on which the person has an identifiable presence. However, a person's social network is not limited to other people who engage with a social networking environment, or even any one specific social networking environment. By way of illustration, a person's social network may include the people, groups or entities in the person's email directory. As another illustration, if a person has a persistent identifiable presence on Facebook, and a persistent identifiable presence in Linked-In, that person's social network may include other people or entities that have persistent identifiable presences on Facebook (e.g., Facebook “friends”), and may include other people or entities that have persistent identifiable presences on Linked-In.

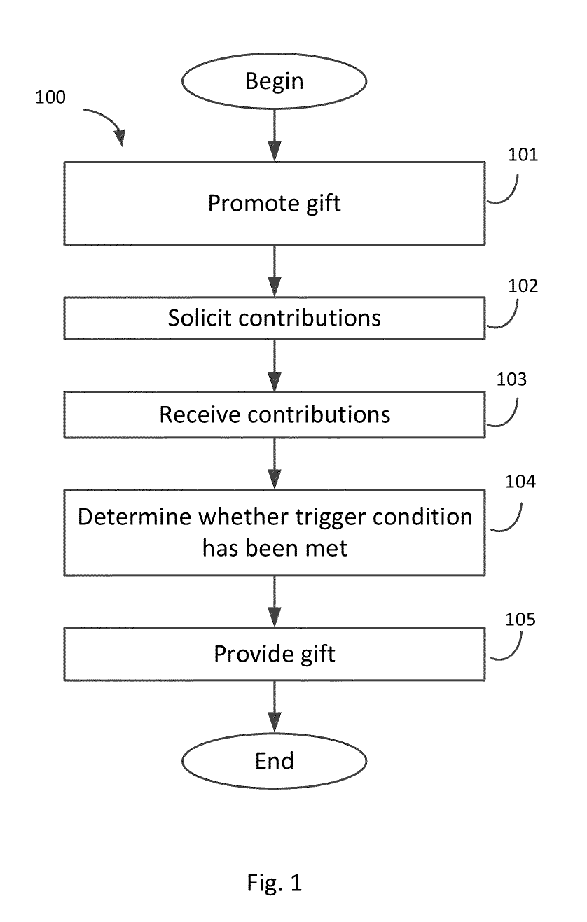

An illustrative embodiment of a method or process of engaging a person's social network is illustrated in the flow chart 100 in FIG. 1 and described below.

Promotion

The method 100 begins by promoting a potential gift item to members of the recipient's social network (step 101). The process of promoting a potential gift may be referred to as a “promotion.”

In various embodiments, the gift item may take a variety of forms. For example, the gift item may be good or a service, or a credit instrument that may be applied towards the purchase of a good or service from a vendor, such as a gift card or gift certificate, for example. In some embodiments, a credit instrument has value only with an identified vendor (e.g., an iTunes gift card only has value with Apple's iTunes service).

In an illustrative embodiment, promoting a potential gift item includes sending a message to one or more members of the recipient's social network, identifying the ongoing promotion. The message may be sent via one or more social networking environments, or by other ways, such as to an email address associated with a member of the recipient's social network, for example. Indeed, promoting a potential gift may be done in a variety of ways. For example, information about a potential group gift may be posted to the recipient's common area of the social web site (i.e., a location that also is viewable by other users of the social web site), such as the recipient's wall if on Facebook for example, or with a personal messages over a social networking environment, to name but a few additional examples.

In some embodiments, the message identifying the promotion includes, for example, information about the potential gift and/or information describing a conditional vendor contribution. Other embodiments include in the message other details, such as a time frame for the promotion (e.g., a deadline by which the promotion will be terminated), or information about alternative gifts or alternative vendor contributions, for example.

The conditional vendor contribution may include a variety of discounts, financial contributions, credits or other incentives by which a vendor of the gift item may contribute to the gift.

In various embodiments, the condition that trigger's a vendor's contribution may take a variety of forms. Indeed, the incentives and conditions may be limited only by the vendor's imagination. Some illustrative examples are described below.

A. In some embodiments, a vendor may make a financial contribution towards the gift price if the sum of contributions from members of the recipient's social network meet or exceed a target amount. In some embodiments, the target amount may be the gift price. In this way, the vendor has received (either directly from contributors or from contributors through an agent working for the vendor) an amount sufficient to purchase the gift for the recipient. However, in other embodiments, the target amount may be less than the gift price. In such embodiments, the vendor may agree to make a financial contribution towards the gift (or in other words, to the recipient) even if the sum of contributions ultimately contributed by members of the recipient's social network is less than the gift price.

B. In some embodiments, a vendor may make a financial contribution towards the gift price if a minimum (e.g., pre-defined) number of members of the recipient's social network make contributions.

C. In some embodiments, a vendor may make a financial contribution towards the gift price if (a) at least minimum number of members of the recipient's social network make contributions, and (b) the sum of contributions from members of the recipient's social network meet or exceed a target amount as described above.

D. In alternate embodiments, the vendor may apply a discount to the gift price rather than, or in addition to, making a financial contribution as per the embodiments described above. As such, in such embodiments, the vendor may agree to provide a discount from the gift price even if the trigger condition (e.g., sum of contributions; minimum number of contributors, etc.) ultimately goes unmet.

Some embodiments may include more than one conditional vendor contribution, including tiered conditional vendor contributions in which additional vendor contributions, and/or increasingly valuable vendor contributions, and/or differing species of contributions (e.g., financial contribution and discount) are triggered by various conditions. In some embodiments, a vendor may contribute an initial amount towards the item if a first condition is met, or a greater amount if a second condition is met. In alternate embodiments, a vendor may contribute an initial percent of the gift price if a minimum number of members of the recipient's social network make a contribution towards the gift, and may contribute greater percent of the gift price if a total of a larger number of members of the recipient's social network make a contribution towards the gift. In some embodiments, the vendor's contribution may be the sum of two or more contributions.

Solicitation

The method 100 also solicits contributions from the members of the recipient's social network (step 102) towards the potential gift. In some embodiments, the solicitation step 102 may be combined with, or inherent in, the promotion step 101.

In some embodiments, the potential gift may have a known price (for example, if the potential gift is an identified good or service). As such, in various embodiments the contributions may be applied to that price. Indeed, a solicitation for contributions may detail the price and ask for contributions towards the price.

In other embodiments, the potential gift may not have a known or fixed price, for example if the potential gift is a gift card or other credit instrument. As such, in various embodiments the method may apply contributions to increase the value of the gift card or other credit instrument. Indeed, a solicitation for contributions may specify that the potential gift is to be a gift card or other credit instrument, and ask for contributions to fund the gift card or other credit instrument.

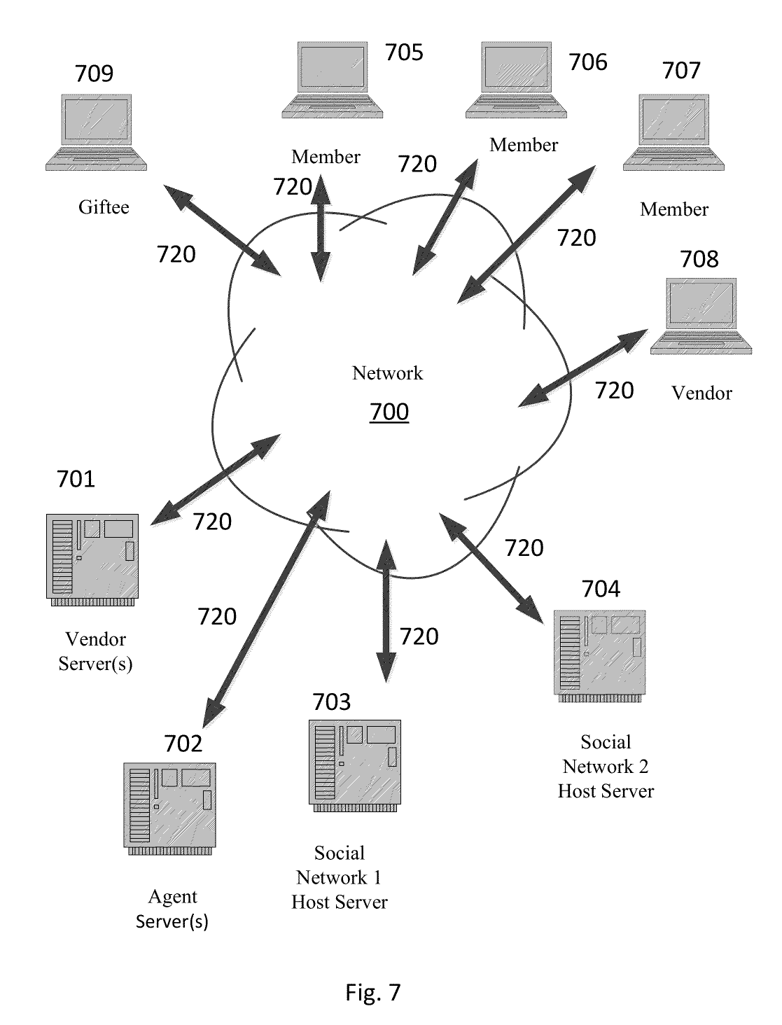

Some embodiments may provide contribution suggestions to a potential contributor. For example, in some embodiments, a potential contributor may accesses a web page, or profile or page in a social networking environment, to consider making a contribution. The page may display one or more suggested contributions on a client device of potential contributor (e.g., on a display screen of computer 705 as schematically illustrated in FIG. 7). A suggested contribution may, for example, be a suggested monetary amount (e.g., $5, $10, $100), a percentage of the item's purchase price (e.g., 5%, 10%, 75%). In some embodiments, the potential contributor's activation of the displayed suggested contribution (e.g., clicking on the a suggested contribution) initiates the contribution process. In some embodiments, the potential contributor's activation of the displayed suggestion causes receipt of a contribution from that person by a server running code for receiving one or more contributions from one or more contributors.

Contributions from a contributor may take a variety of forms. In some embodiments, a contribution may simply be a financial contribution. A financial contribution may, for example, be made by sending cash or a check, or by paying with a credit card or through third party service such a PayPal for example. In some embodiments, a contributor may make her contributions conditional (i.e., a conditional contribution) on a trigger condition being met. For example, a contributor may make her contribution conditional on the total amount of contributions, such that the contributor's contribution vests (or is triggered, or locked-in) only if the sum of contributions (and/or other conditional contributions) meets or exceeds a certain sum, such as the gift price for example. In this way, if the contribution trigger is not met—for example if other members of the recipient's social network fail to make sufficient contributions—then the contributor is not committed to her contribution and may, for example, choose to direct those funds to an alternate gift of her choosing.

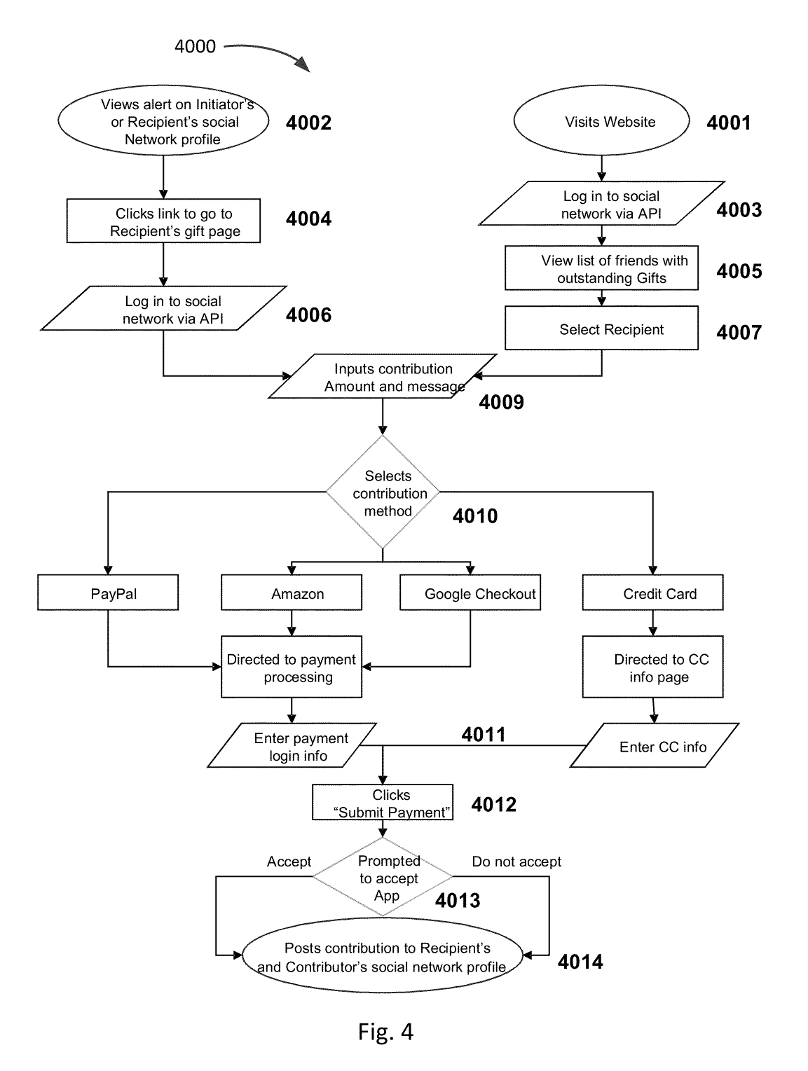

FIG. 4 shows an exemplary process 4000 for the contributor to make a contribution to a collectively-given gift. To that end, a friend of the recipient visits the website and logs in by means of his/her social network via the user interface (step 4001 and 4003). At that point, he/she can view a list of friends with outstanding/unexpired gifts (step 4005). The friend then can select the recipient (step 4007) and make a contribution by entering a contribution amount (step 4009), thus causing the friend to become a contributor.

Alternatively, a contributor can view an alert on the initiator's or recipient's social networking profile or alerts area (step 4002). After clicking the link embedded in the alert, the contributor is directed to recipient's gift page (step 4004) where he/she can log in to the website with their social network account via the API (step 4006). The contributor then enters the contribution amount (step 4009).

After inputting contribution amount and message, the contributor selects contribution method (step 4010), which may include PayPal, Amazon, Google Checkout, credit cards, or others. The contributor then clicks ‘submit payment’ (step 4012). The contributor may be prompted to accept the service's social network application (step 4013), and the contribution (without amount) information may be posted to both the contributor's and recipient's social network profiles (step 4014).

Receipt of Contributions

To gather contributions, the method also includes a step of receiving contributions (step 103). Contributions may come from members of the recipient's social network, but can also come from people or entities that are not members of the recipient's social network, and/or from the recipient himself. Indeed, in various embodiments, the recipient may be deemed to be a member of the recipient's social network. The step of receiving contributions may include tracking various information, such as the sum or total contributions received, the number of unique contributors (in which anonymous contributors may be deemed to be a single contributor, or each a unique contributor), or both, to name but a few examples.

In illustrative embodiments, the contributions are held by the party running the promotion (e.g., a promoter), such as a vendor or an agent engaged by the vendor, and not by the potential recipient, or the initiator, or by a member of the recipient's social network. As such, in some embodiments, a contributor (or the contributors) provide contributions to the vendor (or vendor's agent), and not to the recipient, such that the financial relationship is between the contributor and the vendor.

In some embodiments, the promotion may be defined to have a pre-determined lifespan. For example, a promotion may be defined to terminate or expire at a time certain (for example, at a given day and time), or after the passage of an amount of time after the promotion begins (for example, seven days after the promotion is commenced). In some embodiments, the promotion may be defined to terminate when one or more of the trigger conditions is satisfied. As such, in some embodiments the receipt of contributions may be time-limited.

Conditional Vendor Contribution

At step 104, the method 100 determines whether a trigger condition has been satisfied. Then, at step 105, a gift may be provided to the recipient.

In some embodiments, the gift (or a portion of the gift) provided to the recipient may be determined by whether a trigger condition has been met. In some embodiments, the gift provided to the recipient is simply the item promoted during the promotion. In alternate embodiments, the gift may be a gift card or gift certificate from the vendor, a debit card, a store credit or other credit instrument such as an iTunes gift card for example. In some embodiments, the gift may take the form of a discount coupon from the vendor, such as a discount provided as a vendor contribution as discussed above, either alone or in addition to any of the embodiments identified above. Indeed, the possible form of the gift may be limited only by the imagination of the vendor, recipient, or members of the recipient's social network.

In some embodiments, the gift may be a credit instrument in an amount less than, or equal to, the sum of the contributions received. For example, in some embodiments, the vendor, the vendor's agent, or another entity running the promotion may charge a fee for their services, and may deduct that fee from the amount of the gift.

If the gift takes the form of a gift card, debit card, or other credit instrument, the value may be in an amount sufficient to purchase the item promoted during the promotion. In alternate embodiments the amount may be for less than or greater than an amount sufficient to purchase the item promoted during the promotion. In other embodiments, the amount may be equal to the sum of contributions received, or equal to the sum of the contributions received plus a vendor contribution.

Fulfillment

Finally, at step 105, a gift is provided to the recipient. Some embodiments offer the recipient an opportunity to select the gift to be provided to the recipient. For example, the vendor, or an agent acting on the vendor's behalf, may contact the recipient by sending a message, such as by contacting the recipient through one or more social network environments, for example. Such contact may offer the recipient a number of options, such as (i) send the gift item to me, (ii) send a gift card in the amount of the gift to me, (iii) apply the gift amount as a credit against my account with the vendor, (iv) send an alternate gift of my choice to me, or (v) forward the gift to a person or entity of my choosing; (vi) selecting or accepting a lower priced gift offered by the same vendor, (vii) selecting or accepting a gift card for less than or equal to the sum of contributions, (viii) selecting or accepting a lower-priced gift and a gift card for the remaining contributions beyond the price of the lower-priced gift, to name but a few.

Initiation of Process

A process (e.g., process 100) of engaging a recipient's social network may be initiated in a variety of ways. The person or entity that initiates the process may be referred to as an “initiator.” In various illustrative embodiments, the initiator may be a vendor, and/or a member of the recipient's social network, or friend or relative of the recipient, even if that friend or relative is not a member of the recipient's social network. Indeed, in some embodiments the initiator may be the recipient himself, but other embodiments exclude the recipient as an initiator.

In some embodiments, the step of initiating a process of engaging a recipient's social network provides an opportunity for the initiator to specify details of the promotion. For example, in some embodiments, the initiator may specify one or more of the item to be promoted, the recipient, the duration of the promotion, one or more target conditions, one or more conditional vendor contributions, and/or alternate gift options for the recipient, etc. As such, in some embodiments a web page or page within a social networking environment may display to the initiator a number of options for some or all of the foregoing details.

In some embodiments, the information that defines a promotion is already known by a promoter (e.g., if the promoter or initiator is the vendor). In some embodiments, the promoter may be a person or computer within a vendor's system for engaging a recipient's social network. In other embodiments, the promotion may be performed, in whole or in part, by an agent engaged by, or on behalf of, a vendor. In such embodiments, the promoter may be a person or computer within the agent's system for engaging a recipient's social network.

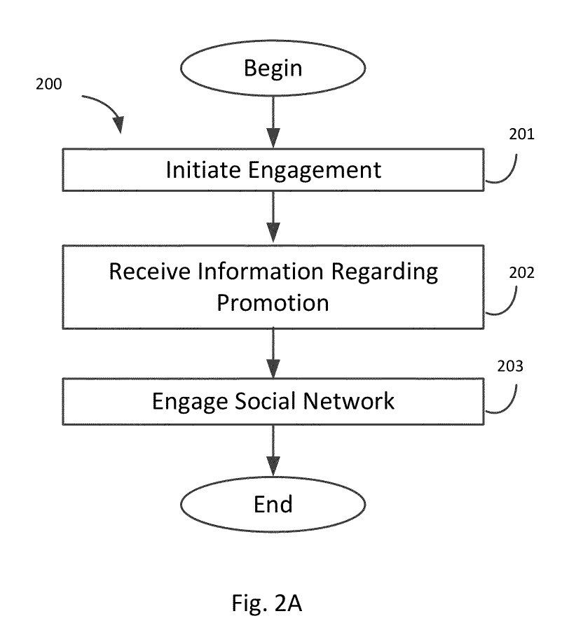

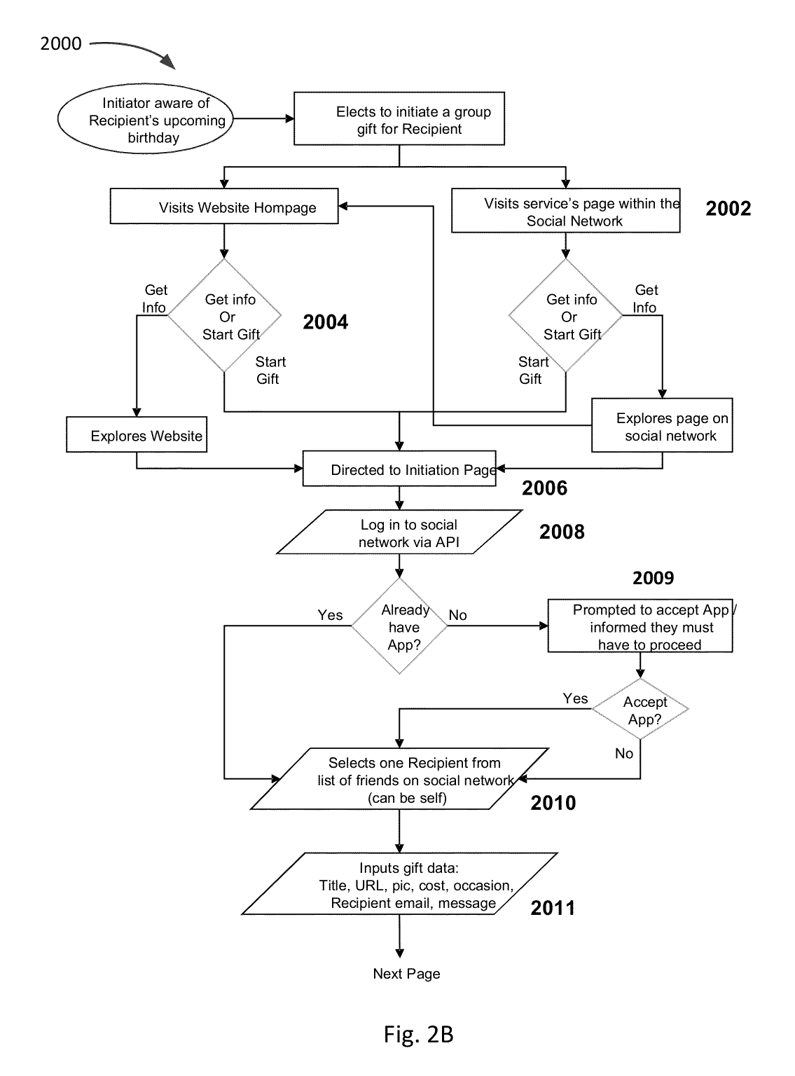

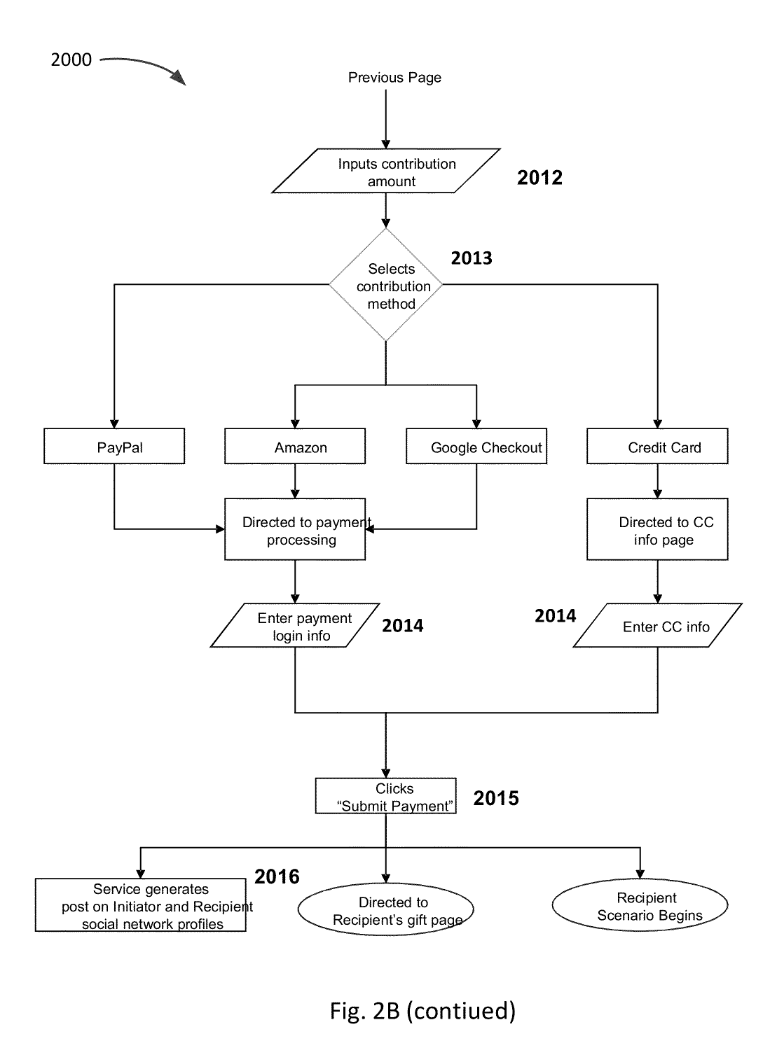

In other embodiments, new or updated information about the promotion may be provided to the promoter prior to, simultaneously with, or after the initiation of the process. For example, the process may begin with the step of sending to, or receipt by, a promoter of information relating to a desired promotion, as schematically illustrated by step 202 in the initiation method 200 of FIG. 2A. In various embodiments, the sending and/or receipt of such information may be performed by on or by one or more computer servers. Once the promoter has the information, the promoter engages the recipient's social network (step 203), for example by the method 100 detailed above.

FIG. 2B shows an illustrative process 2000 for initiating a collective gift purchase in a social network. Among others, the social network may be the Facebook or LinkedIn social networks. The process begins when a user decides to give a gift to the friend. The user thus elects to initiate a group gift for the recipient. First, the initiator visits the website of a service performing significant portions of the illustrative process (e.g., the website of a promotor). Alternatively, the initiator may visit the service's page within the social network (step 2002).

At that point, the initiator can choose 1) to start a gift or 2) get more information on the site (step 2004). If the initiator selects to start a gift, the initiator is directed to an initiation page (step 2006) of the service where the initiator logs into the network site (e.g., a web site) with their social network identity by means of the application programming interface (step 2008). The user then is prompted to accept the service's social network application if they do not already have it (step 2009).

Next, the initiator can select the recipient from list of friends (can be him/herself) on the social network (step 2010). After the initiator enters gift data, which can include, among other things, title, URL, picture, cost, occasion, recipient's email and message (step 2011), the initiator inputs their starting contribution amount toward the gift (step 2012). The initiator then can select the contribution method, e.g., PayPal, Amazon, Google Checkout, or Credit card (step 2013), enter the necessary payment information (step 2014), and then submit payment (step 2015). After the initiator enters the payment information, the service may automatically post an alert to the recipient's social network profile (step 2016), which includes a link to direct the recipient's friends to the recipient's gift page, prompting the recipient's friends to contribute as well.

Recipient Input

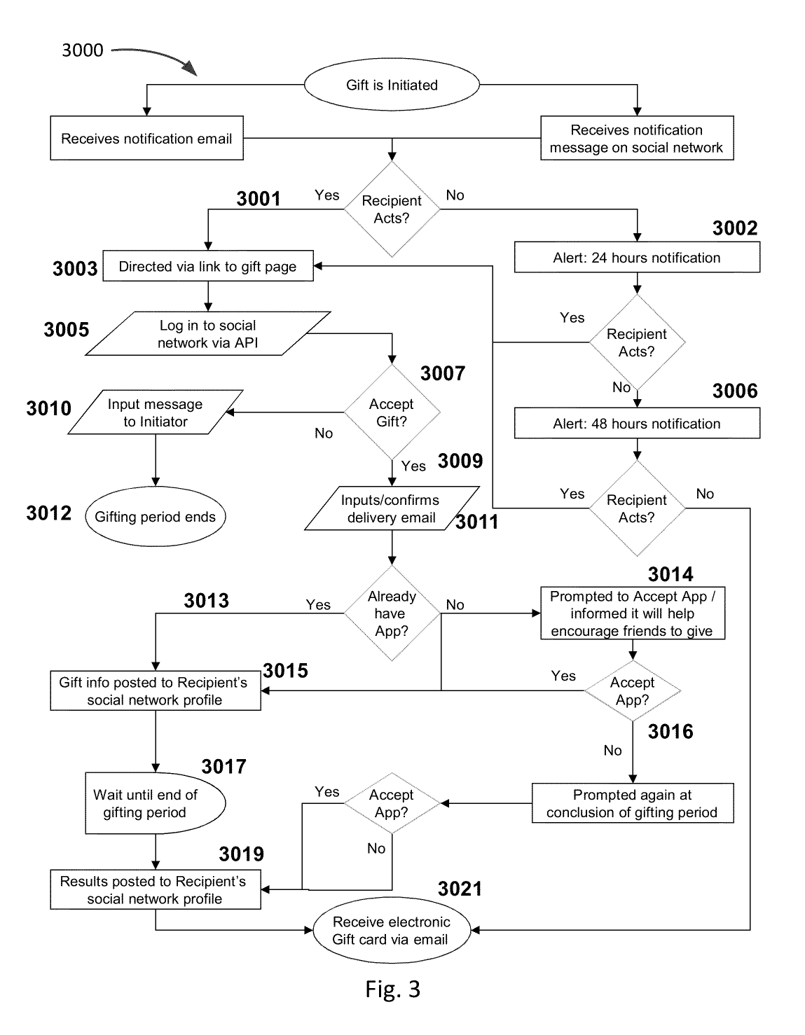

FIG. 3 shows an illustrative, optional process 3000 by which the recipient may accept or reject a gift. After the gifting process is started, the recipient will receive notification message from the service on the social network and/or by email. If the recipient reacts to the notification (step 3001) by selecting/clicking a link/selection option in the message, the recipient is directed to a gift page via the selection option (step 3003) where the recipient logs in to the website with their social network identity by means of the application programming interface (step 3005).

At the gift page, the recipient is asked whether he/she would accept the gift (step 3007). If the recipient accepts the gift (step 3009), he/she inputs/confirms delivery email or other delivery address (step 3011). Whether or not recipient already has the service's application for the social network (step 3013), the gift information may be posted to the recipient's social network profile for a specified time period (the “gifting period”) (step 3015). When the gifting period concludes (3017), the contribution results are received by the service and posted to recipient's social network profile (step 3019). The recipient then receives an electronic gift card via email, regular mail, or other means for the amount collected less fees (step 3021).

Alternatively, if the recipient selects not to accept the gift, the recipient may input a message to initiator or promoter (step 3010). This stops the collectively-given gift process (step 3012).

If recipient does not have the service's social network application, the recipient is prompted to accept the application (step 3014). The gift information may be posted to the recipient's common area of the social web site (i.e., a location that also is viewable by other users of the social web site), such as the recipient's wall if on Facebook (3015), and the remaining steps (3017 to 3021) will be completed. If the recipient selects not to accept the application (step 3016), he/she is prompted again at conclusion of gifting period (step 3018). If he/she selects to accept the application, the results may be posted to recipient's social web common area (step 3019) and the recipient will receive an electronic gift card via email (step 3021). If the recipient still selects not to accept application, he/she will receive electronic gift card via email (step 3021).

Alternatively, if the recipient does not react to the gift notification messages, the recipient will receive an additional notification at some time period, such as 24 hours, after the gift card was initiated (step 3002). If the recipient reacts to the notice during the allotted time period, he/she will be directed to gift page (step 3003). If the recipient does not react to the notification during that time period, the recipient will receive an additional notification at some later point after the gift initiation (step 3006). If the recipient reacts to this later notice, he/she will be directed to a gift page via link (step 3003). If the recipient does not react to the later notification, the service will email an electronic gift card to the recipient (step 3021) after the conclusion of the gifting period. Alternatively, the service can provide further notification periods based on some criteria, such as an option or configuration entered by the initiator.

### Illustrative Examples

Some aspects of various embodiments may be illustrated by the following, non-exhaustive examples. The examples supplement, but do not limit, the generality of the disclosure herein, or any claims appended hereto.

### Example 1

In a first example, Bill is the recipient, and has an upcoming birthday. Jane is Bill's friend and wants to give him a new sweater for his birthday, but would like to invite other friends of Bill to contribute as well.

Jane knows that Bill has included the sweater on a “wish list” on the web site of the sweater retailer (i.e., the vendor). The vendor has already determined that anyone using a group gifting model to give a sweater to a recipient will qualify for a $20 contribution from the retailer, if other contributors raise the remaining cost of the sweater (i.e., $100).

Accordingly, Jane (i.e., the initiator) uses an embodiment of the process described, and begins with a contribution of $50. The process automatically posts to Bill's social network profile, prompting Bill's other friends to contribute as well. Members of Bill's social network (e.g., Bill's Facebook “friends”) collectively contribute another $50, so that the sum of the contributions totals $100. After the gifting period concluded, the process determines that the retailer's condition has been satisfied—Jane and the other contributors have raised the remainder of the purchase price, and as such the retailer contributes the last $20. Therefore, the retailer forwards the sweater to Bill. Alternately, in some embodiments, the retailer may also send to Bill a gift card with a list of contributors (e.g., via email or the social network).

If the sum of contributions exceeds the remainder of the purchase price, the retailer may send to Bill a gift card for the amount by which the sum of contributions exceeds the remainder of the purchase price.

If the sum of contributions fails to meet the remainder of the purchase price (e.g., the sum of contributions is less than $100), then the retailer may send to Bill a gift card in the amount of the sum of contributions. Alternately, the retailer may offer to Bill the option of using the sum of contributions to purchase a different gift item. Some embodiments also provide a final opportunity, even after the deadline for making contributions, for the recipient to make a contribution in an amount sufficient to satisfy a condition and therefore trigger a conditional vendor contribution.

### Example 2

A retailer is linked or friended to Bill through a social network, and knows that Bill will soon celebrate a birthday. Accordingly, the retailer (i.e., the initiator, and also the vendor, in this example) uses an embodiment of the process described, and promotes the gift of a gift card along with a conditional vendor contribution of $25. The retailer will contribute $25 to a gift card for Bill if at least five other people also make contributions to the gift by a certain deadline.

The retailer posts a page on its website, or on its own social media page, to accept contributions. A server under the control of the retailer receives contributions from anyone who wants to contribute, and aggregates the contributions. One or more contributions may even be made by Bill himself.

At the deadline, the server counts the number of contributors who have made contributions. If at least five contributions have been received by the deadline, then the retailer (or the server, or another computer acting on behalf of the retailer) sends, or causes to be sent, a gift card (or other credit instrument) to Bill in the amount of the sum of contributions, plus the retailer's contribution of $25.

### Example 3

A retailer desires to engage Bill's social network, and knows that Bill would like a sweater from the retailer.

Accordingly, the retailer engages a third party (the “aggregator” or “promoter”) to do so, as an agent of the retailer. The retailer provides to the aggregator information about the promotion, including a gift item (e.g., the sweater that Bill wants), the price of the sweater (for example, $120), the time frame of the promotion (for example, ends on Bill's birthday), and a conditional vendor discount (e.g., the vendor will contribute $30 if other contributors raise at least $50. In other words, the retailer's conditional contributions vests at a sum of contributions that is less than the remainder of the price. Stated alternately, the retailer's conditional contribution vests even though the sum of the contributions of other contributors is less than the price. The promotion continues until the deadline, and the retailer provides a gift (e.g., a credit instrument or the sweater itself) to Bill, as described above.

### Example 4

Bill maintains a wish list on the website of his favorite clothing retailer. The retailer knows that Bill will soon celebrate a birthday, and that Bill wants a $200 sweater from the retailer.

Accordingly, the retailer (i.e., the vendor and the initiator in this example) uses an embodiment of the process described, and promotes the gift of a gift card along with a two-tiered conditional vendor contribution. The retailer will contribute a ten percent (10%) discount coupon to a gift to Bill if others contribute at least $40 to a gift card for Bill by a certain deadline. Given the $200 price of the sweater, the ten percent discount is effectively worth $20 to Bill, although the contribution does not require any actual cash or credit outlay by the retailer.

In addition, or in the alternative, the retailer will contribute $45 towards the purchase price if others contribute at least $150 towards the purchase price.

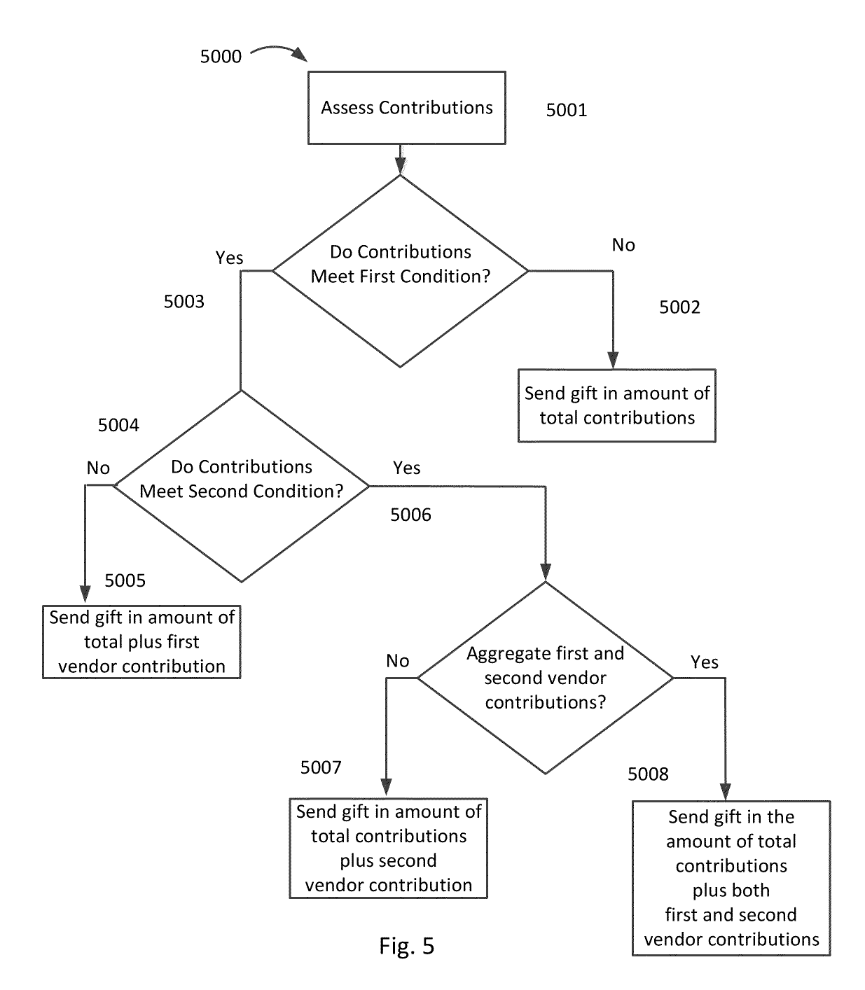

At the deadline, the retailer assesses the contributions, for example as illustrated at item 5001 in the flow chart 5000 of FIG. 5. If the sum of contributions fails (5002) to meet the first condition (i.e., in this example, the sum of contributions is less than $40) the retailer sends to Bill a gift card in the amount of the total contributions, but does not include any vendor contribution.

If the sum of contributions meets (5003) the first condition but not the second condition (5004) (i.e., in this example, the sum of contributions is at least $40 but less than $150), the retailer sends to Bill a gift card (5005) in the amount of the total contributions, along with the discount coupon for ten percent (10%) off of the purchase of the sweater. However, if the sum of contributions also meets (5006) the second condition (i.e., in this example, the sum of contributions is at least $150), the retailer sends (5007) to Bill a gift card in the amount of the total contributions plus the retailer's contribution of $45.

In an alternate embodiment, if the sum of contributions meets the second condition, then the retailer may send (5008) to Bill a gift card in the amount of the total contributions plus both the discount coupon and the gift card in the amount of the total contributions plus the retailer's contribution of $45.

### Example 5

Using a computer server, a retailer (i.e., the vendor and initiator in this example) sends an email announcement of a potential gift to some of Bill's friends. The email includes a link to a page on the retailer's website. Recipients of the email (or anyone else to receive a copy of the email) can access the web page via the Internet, and from that page can make a contribution towards the potential gift. Contributions are received at a server and processed according to various embodiments described herein, and a gift is sent to Bill.

As such, a vendor may engage a recipient's social network without the use of a social networking environment. In other embodiments, however, the web page may be a page in a social networking environment.

### Example 6

In another example, Bill is the recipient, and has an upcoming birthday. Jane (i.e., the initiator in this example) is Bill's friend and wants to give him a gift card to her favorite retailer (i.e., the vendor in this example) for his birthday, but would like to invite other friends of Bill to contribute to the gift card as well.

The vendor has already determined that anyone using a group gifting model to give a gift card will qualify for a $20 contribution from the retailer, if other contributors raise at least $100 towards the gift card.

Accordingly, Jane uses an embodiment of the process described, and begins with a contribution of $50. The process automatically posts to Bill's profile in a social networking environment, prompting Bill's other friends to contribute as well. Members of Bill's social network (e.g., Bill's Facebook “friends”) collectively contribute another $50, so that the sum of the contributions totals $100.

After the gifting period concluded, the process determines that the retailer's condition has been satisfied—Jane and the other contributors have raised the minimum of $100. Therefore, the vendor contributes an additional $20 toward the gift card, and then forwards to Bill a gift card in the amount of the total contributions ($100) plus the vendor contribution ($20), so that the gift card is for a total of $120. If the total contributions had not met the minimum ($100), then the vendor would send to Bill a gift card in the amount of the total contributions (e.g., in this example, less than $100), but not including the vendor contribution.

### Example 7

An initiator desires to initiate a group gift for a recipient using a network, such as network 700 in FIG. 7, for example. The initiator accesses a web page or profile on a social networking environment to send an initiation signal to a server acting as the promoter (e.g., 701, 702), and the server (e.g., 701, 702) receives the initiation signal. For example, the initiator may be a member of the recipient's social network using computer 705. Alternately, the initiator may be a vendor who desires to engage the recipient and the recipient's social network. Such a vendor may access the web page or profile using vendor server 701, for example.

In various embodiments, the web page or profile may reside on the vendor's server (701), or on an agent's server (702). In other embodiments, the page or profile may reside on a social network host server (e.g., 703, 704). If the page or profile resides on a social network host server (e.g., 703, 704), such server (e.g., 703, 704) may forward the initiation signal to a promoter (e.g., 701, 702). For ease of reference, the remainder of this example will refer to server 701 as the “promoter.”

If the promoter (701) already has the parameters of the potential gift, for example if the vendor has previously supplied such parameters, then the promoter (701) may immediately initiate the promotion method. Alternately, new or additional promotion data may be sent to the promoter (701) (for example, by the vendor) and received by the promoter (701).

Next, the promoter (701) posts a message on a user's page in a social networking environment, the message identifying the potential gift, and soliciting contributions to the gift. Of course, a message could also have been sent by email, by posting it on a common area of a social web site (i.e., a location that also is viewable by other users of the social web site), such as the recipient's wall if on Facebook for example, or with a personal messages over a social networking environment, to name but a few additional examples.

A second server (e.g., 702) receives at least one contribution from at least one contributor. In some embodiments, the first server and second server may be the same computer (e.g., vendor server 701, or agent server 702). The second server (702) then aggregates the one or more contributions to produce aggregated contribution data, and determines, based on the aggregated contribution data, whether a trigger condition has been satisfied. Finally, the second (702) server determines a gift to be provided to the recipient, the gift depending on whether the condition has been satisfied. Then, a server (e.g., vendor server 701; agent server 702) may send the gift to the recipient. If the gift can be delivered electronically (e.g., a media file, or electronic credit instrument), then in some embodiments the server (e.g., vendor server 701; agent server 702) may send the gift to the recipient's computer (709).

System

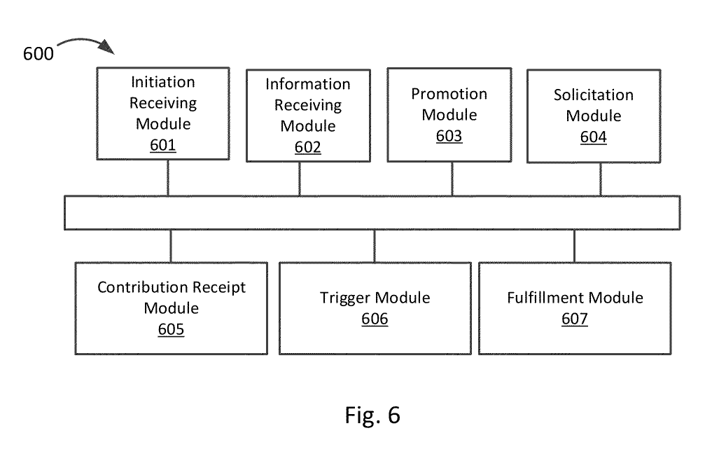

An embodiment of a system 600 for engaging a recipient's social network is schematically illustrated in FIG. 6. The system may include various modules for implementing the various functions performed in various embodiments described herein.

In the embodiment 600 of FIG. 6, the system 600 includes an initiation receiving module 601 for receiving an initiation signal or command, for example from an initiator such as a vendor, a friend of a recipient, or in some embodiments even the recipient himself.

The system may also include an information receiving module for receiving promotion information (e.g., gift promotion data, or “item promotion data”), such as new or updated information about the gift item, the promotion duration, the recipient, and/or one or more conditional vendor contributions, for example.

In addition, the system 600 includes a promotion module, to engage the recipient's social network, as described in various embodiments herein, for purposes of promoting the gift (e.g., the gift promotion data) and opportunities for members of the recipient's social network to make contributions towards the gift.

The system 600 also includes a solicitation module 604, to solicit contributions towards the gift, as described in various embodiments herein. In some embodiments, the solicitation module 604 may be combined with the promotion module 603.

To receive contributions, the system also includes a contribution receipt module 605. In some embodiments, the contribution receipt module 605 may also track the sum of contributions, and/or the total number of contributors. Indeed, in some embodiments, the contribution receipt module 605 may also aggregate the sum of such contributions.

A trigger module 606 assess the data (e.g., sum of contributions, number of contributors) to determine whether one or more conditions have been met. In some embodiments, the trigger module 606 also determines which, if any, vendor contributions are to be included in the gift to the recipient.

In embodiments in which a third party implements some or all of the process for a principal, such as an agent or aggregator engaged by a vendor, for example, the third party may charge a fee to its principal. For example, in some embodiments the fee may be a function of the sum of contributions, or the number of unique contributors, or a combination of those factors. In such embodiments, the trigger module 606 may determine the amount of the fee.

The system 600 also includes a fulfillment module 607 to send the gift to the recipient, as described in various embodiments herein.

In various embodiments, some or all of the modules or functions of the system 600 may be implemented on a single computer server, or various modules or functions may be implemented on a multiple computers. For example, in some embodiments, all of the functions are performed on computers under the control of a single person or entity. For example, in some embodiments, the single person or entity may be the vendor of a gift item, while in other embodiments, the single person or entity may be an agent engaged by the vendor to perform the functions. A system may be under the control of a single person or entity even if the functions are performed at different physical places, or by computers if different physical places.

In other embodiments, some of the functions may be implemented and performed on computers under the control of a first person or entity, and some of the functions may be implemented and performed on computers under the control of a second person or entity, which second person or entity is an agent of, or otherwise coordinating its activities with, the first person or entity. As just one example, some of the first person or entity may be the vendor, and the second person or entity may be an agent engaged by the vendor to perform some of the functions. Such systems may be referred to as “distributed entity systems.”

In some embodiments, various methods for engaging a recipient's social network, and/or systems for engaging a recipient's social network, may be implemented on or over a computer network (700), such as the Internet or a local area network (“LAN”) for example, as schematically illustrated in FIG. 7. In other words, one or more computer servers, each in communication with the network 700 via a link 720, may communicate over the network 700 to implement some or all of the various embodiments.

For example, some or all of a system 600 may be implemented on a server 700 (or multiple servers) owned by or under the control of a vendor. Alternately, the vendor may engage an agent to implement portions or modules of the system 600, or perform some or all of the steps of various illustrative embodiments. As such, some or all of the system 600 may be implemented on a sever 702 owned by or under the control of the vendor.

In some embodiments, the recipient may be a member of one or more social network environments, any of which could be implemented on servers or systems 703, 704 dedicated for that purpose.

People or entities that engage with the system 600 or participate in execution of an embodiment of a method may do so via various computers or terminals that can communicate through the network 700. For example, members of the recipient's social network may engage via their own terminals (e.g., computers, smart phones, tablets) 705, 706, 707. Similarly, a vendor may engage via a terminal 708, and a recipient may engage via a terminal 709.

A variety of embodiments may employ some or all of the concepts described herein. For example, in accordance with one embodiment of the invention, a method initiates a gift for a given item for a given person, and sets a time limit to contribute toward the gift. This gift has a certain cost. The method then forwards a message to a plurality of third parties using a social media site, and provides the capability to receive value for the gift from the third parties or their agents. Finally, the method forwards gift indicia to the given person after the set time limit has elapsed.

Among other things, the gift may be a good or service, and the value may be money value. The gift indicia may include any of a number of things, such as a physical gift card or a message with a gift code (e.g., an email). In addition or alternatively, the gift indicia may include information relating to the value of the gift indicia.

In accordance with another embodiment, a method forwards a first message to a given person. This first message may have information relating to a product and/or service, a total cost, an initial contribution, a specified time, and a selection option. Next, the method receives a selection message (i.e., upon selection of the selection option) and responsively forwards a second message to a plurality of third parties. This second message is destined for a social media site. The method then provides the capability to receive value for the product or service, and forwards gift indicia to the given person after the specified time has elapsed.

Illustrative embodiments thus relate to systems and methods implemented by a web service allowing users to make contributions to buy a group gift for a friend or themselves, aided by a social network environment (e.g., Facebook, etc.). The group gift can be decided upon from a specific website where a listing of accepted retailers can be found. A gift initiator can choose to visit the website where the initiator can log in with their social network identity via the social networks' application programming interface and create a group gift account for a friend or themselves.

After a gift account is created, the service generates a unique identification number for the new gift on its servers, and begins a countdown to the end of the pre-determined gifting period, after which the gifting process closes. The service automatically posts to the initiator's and/or recipient's social network profiles, prompting the recipient's other friends to contribute as well. As friends contribute to the gift, funds are compiled under the unique identification number. At the conclusion of the pre-determined gifting period, the sum of all donations to the gift account are tallied. An electronic gift card worth the tallied amount less handling fees then is emailed to the recipient, and a list of contributors are sent to him/her on the social network. If an intended gift was chosen and the gift card amount does not meet said gift amount, the process still continues and said gift card is sent to the gift recipient himself.

One potential application of this social gifting platform would be the ability for retailers to increase their social media marketing potential. Retailers could apply the service as a new form of direct-to-consumer outreach by initiating a gift on their behalf. In such a case, the retailer may contribute a starting amount toward a target gift amount, allowing the remainder of the contributions to come from other users in the recipient's social network or from the recipient himself. Some embodiments of this form of the invention may include one or both of: a minimum contribution value from others before the retailer's contribution takes effect, or a minimum number of additional contributors before the retailer's contribution takes effect.

In other words, using the group gifting platform described above, retailers could initiate a gift for a targeted consumer. For instance, if a potential recipient made his/her interest in certain products of a retailer known (e.g., by posting about them on Facebook, tweeting, blogging, etc.), the retailer may wish to start a birthday gift for that recipient. In such a case, the retailer might put the first amount, e.g., $30 toward a $300 bag, as a group gift for the recipient. As the recipient's friends go to her wall for whatever reason, they will see the notification of the gift initiation, and other friends contributing and, hopefully, contribute money toward the gift as well.

Some requirements may be implemented before the retailer's gift is effective. In the example above, the retailer may require a minimum of $150 (or any amount) of additional dollars to be contributed before their $30 is added to the official total. The retailer also may also require participation from a minimum number of friends before the $30 is added to the total. Importantly, regardless of whether or not the retailer's funds are triggered based on meeting such requirements, all contributions toward the gift, in this example, apply toward an electronic gift card or other gift indicia for that retailer.

This creates a more direct coupon/shopping incentive for a targeted consumer, helping to foster personal relationships between retailers and their clientele, while also publicizing the product/brand among the recipient's social network.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transient computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

It should be noted that references to specific social media devices, such as a “wall” or “alerts,” used by the widely known social media site/network Facebook, are for illustrative purposes only. Those in the art should understand that principles described using those specific devices apply more broadly to corresponding devices on other social media sites. Accordingly, discussion of those specific devices are not intended to limit a plurality of the embodiments. Moreover, some embodiments can apply to network sites that are not so-called “social media” sites. For example, the entire process can be performed by having the service use its user interface to produce emails sent to both recipients and contributors.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:

P1. A non-transient computer readable medium having computer readable code thereon, the computer readable code for engaging a recipient and members of a recipient's social network by promoting a potential gift for the recipient and a conditional vendor contribution towards the potential gift, the computer code including:

code for promoting the potential gift to members of the recipient's social network;

code for soliciting contributions from members of the recipient's social network towards the potential gift;

code for receiving one or more contributions from one or more contributors;

code for determining whether a trigger condition has been satisfied by a pre-determined deadline; and

code for causing a gift to be provided to the recipient, the gift including the conditional vendor contribution if the trigger condition has been satisfied.

P2. The non-transient computer readable medium of P1, wherein the gift is an identified good or service.

P3. The non-transient computer readable medium of P1, wherein the gift is a credit instrument in the amount less than or equal to the sum of the contributions received.

P4. The non-transient computer readable medium of any of P1-P3, wherein the trigger condition is receipt of pre-defined sum of contributions, the pre-defined sum being less than or equal to a pre-defined price of the potential gift.

P5. The non-transient computer readable medium of any of P1-P4, the code further including code for receiving an initiation signal from a member of the recipient's social network, the initiation signal activating the code for promoting the potential gift.

P6. The non-transient computer readable medium of P5, wherein the code for receiving an initiation signal from a member of the recipient's social network includes code receiving an initiation signal from a member of the recipient's social network via a social networking environment.

P7. The non-transient computer readable medium of any of P1-P6, the code further including:

code for receiving an initiation signal from a vendor of the potential gift, the initiation signal activating the code for promoting the potential gift to members of the recipient's social network.

P8. The non-transient computer readable medium of any of P1-P7, wherein the code for soliciting contributions from members of the recipient's social network towards the potential gift further includes code for displaying, on a client device of member of the recipient's social network, at least one suggested contribution, such that the member's activation of one of the at least one displayed suggested contribution causes receipt of a contribution from that member by the code for receiving one or more contributions.

P9. The non-transient computer readable medium of P1, wherein the code for promoting the potential gift to members of the recipient's social network includes at least code for specifying the potential gift and code for specifying a first conditional vendor contribution and a second conditional vendor contribution; and wherein

the code for determining whether a trigger condition has been satisfied by a pre-determined deadline further includes code for determining whether a first trigger condition has been satisfied, and code for determining whether a second trigger condition has been satisfied, the first trigger condition associated with the first conditional vendor contribution and the second trigger condition associated with the second conditional vendor contribution; and wherein

the code for causing a gift to be provided to the recipient includes code for causing a gift to be provided to the recipient wherein the gift includes the first conditional vendor contribution if the first trigger condition has been satisfied, and wherein the gift includes the second conditional vendor contribution if the second trigger condition has been satisfied.

P10. The non-transient computer readable medium of P9, wherein the code for causing a gift to be provided to the recipient includes code for causing a gift to be provided to the recipient wherein the gift includes both the first conditional vendor contribution and the second conditional vendor contribution if the second trigger condition has been satisfied.

P11. The non-transient computer readable medium of P1, wherein the code for promoting the potential gift to members of the recipient's social network includes at least code for sending a message from an initiator to at least one of the members of the recipient's social network notifying the at least one member of the promotion.

P20. A system for engaging a recipient and members of a recipient's social network by promoting a potential gift for the recipient and a conditional vendor contribution towards the potential gift, the system including:

a promotion module configured to promote the potential gift to members of the recipient's social network via at least one social networking environment;

a solicitation module configured to solicit contributions from members of the recipient's social network towards potential gift;

a contribution receiving module configured to receive one or more contributions from one or more contributors;

a trigger module configured to determine whether a trigger condition has been satisfied by a pre-determined deadline; and

a fulfillment module configured to cause a gift to be provided to the recipient, the gift including the conditional vendor contribution if the trigger condition has been satisfied.

P21. The system for engaging a recipient and members of a recipient's social network of P20, wherein the trigger condition is receipt of a pre-defined sum of contributions, the pre-defined sum exceeding the price of the potential gift.

P22. The system for engaging a recipient and members of a recipient's social network of P20, wherein the trigger condition is receipt of pre-defined sum of contributions, the pre-defined sum being less than or equal to the price of the potential gift.

P23. The system for engaging a recipient and members of a recipient's social network of P20, wherein the trigger condition receipt of is a pre-defined sum of contributions, the pre-defined sum exceeding an amount that is (i) the price of the potential gift less (ii) a discount deducted from the price of the potential gift.

The embodiments of the inventions described above are intended to be merely exemplary; numerous variations and modifications will be apparent to those skilled in the art. All such variations and modifications are intended to be within the scope of the present invention as defined in any appended claims.

What is claimed is:

1. A method of engaging a recipient and members of a recipient's social network by promoting a potential gift for the recipient and a conditional vendor contribution towards the gift, the method comprising:
posting, from a first server, a message on a user's page in a social networking environment, the message identifying the potential gift, and soliciting contributions to the gift;
receiving, at a second server, at least one contribution from at least one contributor;
aggregating the one or more contributions to produce aggregated contribution data;
determining, based on the aggregated contribution data, whether a trigger condition has been satisfied;
determining a gift to be provided to the recipient, the gift depending on whether the condition has been satisfied.

2. The method according to claim 1, further comprising providing the gift to the recipient.

3. The method according to claim 1, further comprising causing the gift to be provided to the recipient.

4. The method according to claim 1, wherein the first server and the second server are the same server.

5. The method according claim 1, wherein determining the gift to be provided includes determining whether the gift includes a vendor contribution.

6. The method according claim 1, further comprising, prior to posting, from a first server, a message on a user's page in a social networking environment, the message identifying the potential gift, the step of receiving, at the first server, item promotion data, the item promotion data comprising at least a specification of the potential gift and the price of the potential gift.

7. The method according claim 1, wherein the trigger condition is receipt of a plurality of contributions from at least a pre-defined number of contributors.

8. The method according claim 1, wherein the trigger condition is receipt of pre-defined sum of contributions, the pre-defined sum exceeding a pre-defined price of the potential gift.

9. The method according claim 1, wherein the trigger condition is receipt of a pre-defined sum of contributions, contributed by a pre-defined number of contributors.

10. The method according claim 1, wherein:
determining whether a trigger condition has been satisfied comprises determining whether a first trigger condition has been satisfied, and if so, determining whether a second trigger condition has been satisfied, the first trigger condition associated with a first conditional vendor contribution and the second trigger condition associated with a second conditional vendor contribution; and wherein
the method further comprises causing a gift to be provided to the recipient wherein the gift includes the first conditional vendor contribution if the first trigger condition has been satisfied, and wherein the gift includes the second conditional vendor contribution if the second trigger condition has been satisfied.

11. A non-transient computer readable medium having computer readable code thereon, the computer readable code for engaging a recipient and members of a recipient's social network by promoting a potential gift for the recipient and a conditional vendor contribution towards the potential gift, the computer code comprising:
code for promoting the potential gift to members of the recipient's social network;
code for soliciting contributions from members of the recipient's social network towards the potential gift;
code for receiving one or more contributions from one or more contributors;
code for determining whether a trigger condition has been satisfied by a pre-determined deadline; and
code for causing a gift to be provided to the recipient, the gift including the conditional vendor contribution if the trigger condition has been satisfied.

12. The non-transient computer readable medium of claim 11, wherein the code for promoting the potential gift to members of the recipient's social network comprises code for promoting the potential gift via at least one social networking environment, the code for promoting including at least code for specifying the potential gift and code for specifying a conditional vendor contribution.

13. The non-transient computer readable medium of claim 11, the code further comprising:
code for receiving item promotion data, the item promotion data comprising at least a specification of the potential gift and the price of the potential gift.

14. The non-transient computer readable medium of claim 11, wherein the trigger condition is receipt of a plurality of contributions from at least a pre-defined number of contributors.

15. The non-transient computer readable medium of claim 11, wherein the trigger condition is receipt of pre-defined sum of contributions, the pre-defined sum exceeding a pre-defined price of the potential gift.

16. The non-transient computer readable medium of claim 11, wherein the trigger condition is receipt of a pre-defined sum of contributions, contributed by a pre-defined number of contributors.

17. The non-transient computer readable medium of claim 11, the code further comprising:
code for causing a credit instrument to be provided to the recipient if the trigger condition has not been satisfied, the credit instrument in an amount less than or equal to the sum of the contributions received.

18. A system for engaging a recipient and members of a recipient's social network by promoting a potential gift for the recipient and a conditional vendor contribution towards the potential gift, the system comprising:
a promotion module configured to promote the potential gift to members of the recipient's social network via at least one social networking environment;
a solicitation module configured to solicit contributions from members of the recipient's social network towards potential gift;
a contribution receiving module configured to receive one or more contributions from one or more contributors;
a trigger module configured to determine whether a trigger condition has been satisfied by a pre-determined deadline; and
a fulfillment module configured to cause a gift to be provided to the recipient, the gift including the conditional vendor contribution if the trigger condition has been satisfied.

19. The system for engaging a recipient and members of a recipient's social network of claim 18, the system further comprising:
an information receiving module configured to receive item promotion data, the item promotion data comprising at least a specification of the potential gift and the price of the potential gift.

20. The system for engaging a recipient and members of a recipient's social network of claim 18, wherein the trigger condition is receipt of a contribution from at least a pre-defined number of contributors.
